(19) United States
(12) Patent Application Publication
(10) Pub. No.: US 2024/0184579 A1
(43) Pub. Date: Jun. 6, 2024

(54) MULTI-CORE SYSTEM FOR PROVIDING A COMMUNICATION FUNCTION BETWEEN SOFTWARE COMPONENTS AND A METHOD THEREFOR

(71) Applicants: HYUNDAI MOTOR COMPANY, Seoul (KR); KIA CORPORATION, Seoul (KR); HYUNDAI AUTOEVER CORP., Seoul (KR)

(72) Inventors: Hong Yeol Lim, Incheon (KR); Kyung Taek Kim, Anyang-si (KR); Bong Ju Kim, Yongin-si (KR)

(73) Assignees: HYUNDAI MOTOR COMPANY, Seoul (KR); KIA CORPORATION, Seoul (KR); HYUNDAI AUTOEVER CORP., Seoul (KR)

(21) Appl. No.: 18/130,737

(22) Filed: Apr. 4, 2023

(30) Foreign Application Priority Data
Dec. 6, 2022 (KR) 10-2022-0168982

(51) Int. Cl. G06F 9/30; B60W 60/00

(52) U.S. Cl. CPC G06F 9/3004; B60W 60/001; G06F 9/3017

(57) ABSTRACT

A multi-core system for providing a communication function between software components (SWCs) and a method therefor are provided. The method may include: determining a memory operating as a data buffer, based on an execution cycle of each of the SWCs, when communicating between an SWC executed by a first core and at least one SWC executed by a second core; writing, by the SWC executed by the first core, data in the data buffer; and reading, by the at least one SWC executed by the second core, the data from the data buffer.

### CROSS-REFERENCE TO RELATED APPLICATION

This application claims the benefit of priority to Korean Patent Application No. 10-2022-0168982, filed in the Korean Intellectual Property Office on Dec. 6, 2022, the entire contents of which are incorporated herein by reference.

### TECHNICAL FIELD

The present disclosure relates to technologies of allocating a data buffer when communicating between software components (SWCs) in a multi-core system.

### BACKGROUND

As a powertrain domain, a chassis domain, a body domain, and a multimedia domain driven by electronic control based on various sensors loaded into the vehicle have expanded, recently, it has reached the stage of test-driving autonomous vehicles. In other words, automatic control of the entire vehicle, such as the chassis domain, the body domain, and the multimedia domain, as well as the powertrain domain, such as an engine, a transmission, or an anti-lock brake system (ABS), which is associated with driving of the vehicle, becomes possible due to electronic control units (ECUs) loaded into the vehicle.

Furthermore, an embedded system is applied to a system for electronic control of the vehicle. The embedded system applied to the vehicle is a computer system that embeds software for operating various domains of the vehicle in its hardware to perform only a special function, which is configured to have specific requirements unlike a general personal computer and performs a predefined task.

As several ECUs are installed for each domain in the vehicle, middleware for the vehicle, which is capable of effectively managing each ECU, may be applied. There is an automotive open system architecture (AUTOSAR) as representative middleware for the vehicle. Such an AUTOSAR provides software specifications for the vehicle and an execution environment, which are designed to be used in common by automobile manufacturers. As the structure of electronics mounted on vehicles becomes very precise and complex, AUTOSAR is applied as one of the standardized integrated software platforms to address the complexity of hardware or software.

Meanwhile, an operating system that is ensured in real time is developed to implement embedded software loaded into the embedded system for the vehicle and is mainly applied to develop an application for vehicle control. In other words, a software platform using such an operating system is loaded into most vehicles and is applied to electronics for controlling the entire vehicle, for example, the chassis domain, the body domain, and the multimedia domain as well as the powertrain domain.

An advanced driver assistance system (ADAS) is applied to an autonomous vehicle, and there is an increase in loading active control ECUs for controlling the ADAS. Such active control ECUs are ADAS ECUs such as an automatic emergency braking system (AEB) ECU, a smart cruise control (SCC) ECU, a highway driving assist (HDA) ECU, a traffic jam assist (TJA) ECU, a lane keeping assist system (LKA) ECU, and a parking assistance system (PAS) ECU.

Each of the ADAS ECUs described above is configured to control the powertrain domain, the chassis domain, the body domain, and the multimedia domain based on data (hereinafter referred to as “sensor data”) measured by sensors installed in respective parts of the vehicle.

Meanwhile, an existing method for communicating between an application executed by a first core and at least one application executed by a second core, in an ECU having a multi-core hardware architecture, uses a cache memory as a data buffer without regard to an execution cycle of the application. Thus, the efficiency of the cache memory is degraded and an operation speed of the application is reduced.

Details described in the background art section are written to aid in understanding the background of the present disclosure. Thus, this section may include details that are not considered to be existing technology well known to those of ordinary skill in the art.

### SUMMARY

The present disclosure has been made to solve the above-mentioned problems occurring in the prior art while advantages achieved by the prior art are maintained intact.

An aspect of the present disclosure provides a multi-core system for providing a communication function between software components (SWCs) to determine a memory operating as a data buffer based on an execution cycle of each of the SWCs, when communicating between an SWC executed by a first core and at least one SWC executed by a second core, in the multi-core system. The multi-core system includes a plurality of cores, each of which has at least one memory, to shorten a memory access latency of the SWC and improve an operation speed of an application. Another aspect provides a method therefor.

Another aspect of the present disclosure provides a multi-core system for providing a communication function between SWCs to determine a memory operating as a data buffer among memories included in each core based on an execution cycle of each of applications, when communicating between an application executed by a first core and at least one application executed by a second core, in an electronic control unit (ECU) having a multi-core hardware architecture, to shorten a memory access latency of the application and improve an operation speed of the application. Another aspect provides a method therefor.

Another aspect of the present disclosure provides a multi-core system for providing a communication function between SWCs to determine a memory operating as a data buffer among memories included in each core based on an execution cycle of each of autonomous driving applications, when communicating between an autonomous driving application executed by a first core and at least one autonomous driving application executed by a second core, in an electronic control unit (ECU) having a multi-core hardware architecture, to improve a data access speed of the autonomous driving application. Another aspect provides a method therefor.

The purposes of the present disclosure are not limited to the aforementioned purposes. Any other purposes and advantages not mentioned herein should be more clearly understood from the following description and may be more clearly known by an embodiment of the present disclosure. Furthermore, it may be easily seen that purposes and advantages of the present disclosure may be implemented by means indicated in the claims and a combination thereof.

According to an aspect of the present disclosure, a method for communicating between software components (SWCs) in a multi-core system is provided. The method may include: determining a memory operating as a data buffer, based on an execution cycle of each of the SWCs, when communicating between an SWC executed by a first core and at least one SWC executed by a second core; writing, by the SWC executed by the first core, data in the data buffer; and reading, by the at least one SWC executed by the second core, the data from the data buffer.

In an embodiment of the present disclosure, the data may be runtime environment (RTE) data.

In an embodiment of the present disclosure, each of the first core and the second core may include at least one memory. In an embodiment of the present disclosure, determining the memory operating as the data buffer may include setting the data buffer in the memory included in the first core when an execution cycle of the SWC executed by the first core is shorter than or equal to an execution cycle of the at least one SWC executed by the second core.

In an embodiment of the present disclosure, determining the memory operating as the data buffer may include setting the data buffer in the memory included in the second core when an execution cycle of the SWC executed by the first core is longer than an execution cycle of the at least one SWC executed by the second core.

In an embodiment of the present disclosure, each of the at least one memory may include at least one of a program scratch-pad RAM (PSPR), a data scratch-pad RAM (DSPR), a direct-connected local memory unit (DLMU), a default application memory (DAM), a program flash memory (PFLASH), a data flash memory (DFLASH), or an extension memory (EMEM).

In an embodiment of the present disclosure, the multi-core system may be an autonomous driving electronic control unit (ECU) having a multi-core hardware architecture.

According to another aspect of the present disclosure, a multi-core system is provided. The system may include a linker script in which information about a memory operating as a data buffer is written, a first software component (SWC) that writes data in the data buffer based on the linker script, and a second SWC that reads the data from the data buffer based on the linker script. The first SWC may be executed by a first core and the second SWC may be executed by a second core. The memory may be determined based on an execution cycle of the first SWC and an execution cycle of the second SWC.

In an embodiment of the present disclosure, the linker script may set the data buffer in the memory included in the first core when the execution cycle of the first SWC is shorter than or equal to the execution cycle of the second SWC.

In an embodiment of the present disclosure, the linker script may set the data buffer in the memory included in the second core when the execution cycle of the first SWC is longer than the execution cycle of the second SWC.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing illustrating a configuration of a multi-core system for providing a communication function between software components (SWCs) according to an embodiment of the present disclosure;

FIG. 2 is a drawing for describing a communication scheme between SWCs in a multi-core system according to an embodiment of the present disclosure;

FIG. 3 is a drawing for describing an example of a process of setting a buffer when communicating between SWCs in a multi-core system according to an embodiment of the present disclosure;

FIG. 4 is a drawing for describing another example of a process of setting a buffer when communicating between SWCs in a multi-core system according to an embodiment of the present disclosure;

FIG. 5 is a flowchart illustrating a method for communicating between SWCs in a multi-core system according to an embodiment of the present disclosure; and

FIG. 6 is a block diagram illustrating a computing system for executing a method for communicating between SWCs according to an embodiment of the present disclosure.

### DETAILED DESCRIPTION

Hereinafter, some embodiments of the present disclosure are described in detail with reference to the accompanying drawings. In adding the reference numerals to the components of each drawing, it should be noted that the identical component is designated by the identical numerals even when they are displayed on different drawings. Further, in describing embodiments of the present disclosure, a detailed description of well-known features or functions has been omitted where it would otherwise unnecessarily obscure the gist of the present disclosure. When a component, device, element, or the like, of the present disclosure, is described as having a purpose or performing an operation, function, or the like, the component, device, or element should be considered herein as being “configured to” meet that purpose or to perform that operation or function.

In describing the components of embodiments according to the present disclosure, terms such as “first,” “second,” “A,” “B,” “(a),” “(b),” and the like may be used. These terms are merely intended to distinguish one component from another component, and the terms do not limit the nature, sequence, or order of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

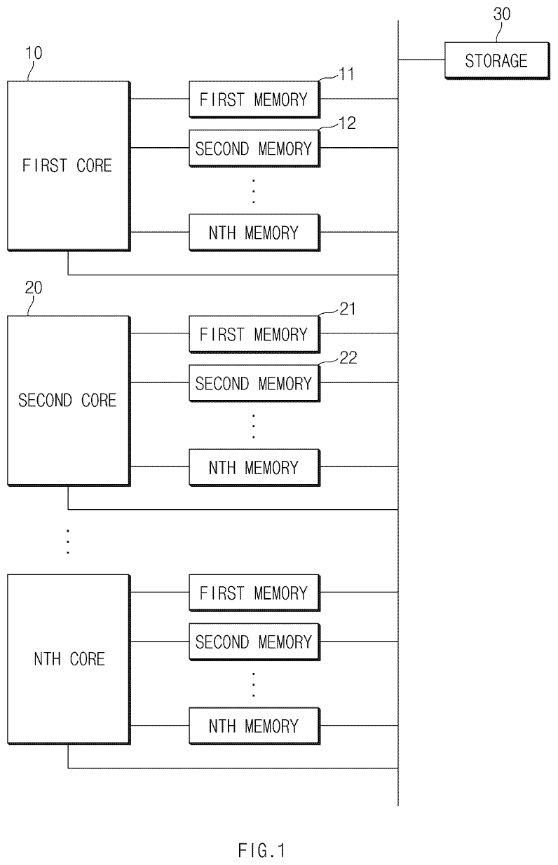

FIG. 1 is a drawing illustrating a configuration of a multi-core system for providing a communication function between software components (SWCs) according to an embodiment of the present disclosure.

FIG. 1 shows the multi-core system for providing the communication function between the SWCs according to an embodiment of the present disclosure. The multi-core system may include a plurality of cores, each of which has at least one memory. In this case, the respective components may be combined into one component and some components may be omitted, depending on a manner that executes the multi-core system for providing the communication function between the SWCs according to an embodiment of the present disclosure. Herein, the multi-core system may be an autonomous driving electronic control unit (ECU) having a multi-core hardware architecture.

Seeing the respective components, first of all, a first core 10 may include at least one memory 11 and 12. In this case, each of the at least one memory 11 and 12 may be an external memory separated from a cache memory which is an internal memory, which may include a program scratch-pad RAM (PSPR), a data scratch-pad RAM (DSPR), a direct-connected local memory unit (DLMU), a default application memory (DAM), a program flash memory (PFLASH), a data flash memory (DFLASH), or an extension memory (EMEM).

Herein, the first core 10 takes a latency of 0-6 cycles to access at least one memory 11 and 12 included in the first core 10 on a hardware structure but takes a latency of 6-18 cycles to access the at least one memory 21 and 22 included in a second core 20. In other words, the time taken for the core to access a memory of another core is much longer than the time taken to access a memory included in the core.

The second core 20 may include at least one memory 21 and 22. In this case, each of the at least one memory 21 and 22 may be an external memory separated from a cache memory which is an internal memory, which may include a program scratch-pad RAM (PSPR), a data scratch-pad RAM (DSPR), a direct-connected local memory unit (DLMU), a default application memory (DAM), a program flash memory (PFLASH), a data flash memory (DFLASH), or an extension memory (EMEM).

Herein, the second core 20 takes a latency of 0-6 cycles to access the at least one memory 21 and 22 included in the second core 20 but takes a latency of 6-18 cycles to access the at least one memory 11 and 12 included in the first core 10.

Storage 30 may store a linker script generated by a developer. Herein, a memory operating as a data buffer is specified for all cases of communicating with each other between SWCs in the linker script. A memory of a core may be specified and which is allocated (or executed on) an SWC with a fast execution cycle as a dataset. Such a linker script may be shared with all cores in the multi-core system.

For example, when SWC A has an execution cycle of 10 milliseconds (ms), SWC B has an execution cycle of 15 ms, and SWC C has an execution cycle of 20 ms, and using 1:1 (data provider SWC to data consumer SWC) communication, a memory of a core that executes SWC A is set to a data buffer when SWC A and SWC B communicate with each other, a memory of the core that executes SWC A is set to the data buffer when SWC A and SWC C communicate with each other, and a memory of a core that executes SWC B is set to a data buffer when SWC B and SWC C communicates with each other. Furthermore, using 1:N (data provider SWC to data consumer SWC) communication, a memory of a core that executes SWC A is set to a data buffer when SWC A communicates with SWC B and SWC C, the memory of the core that executes SWC A is set to the data buffer when SWC B communicates with SWC A and SWC C, and the memory of the core that executes SWC A is set to the data buffer when SWC C communicates with SWC B and SWC A.

Such storage 30 may include at least one type of storage medium, such as a flash memory type memory, a hard disk type memory, a micro type memory, a card type memory (e.g., a secure digital (SD) card or an extreme digital (XD) card), a random-access memory (RAM), a static RAM (SRAM), a read-only memory (ROM), a programmable ROM (PROM), an electrically erasable PROM (EEPROM), a magnetic RAM (MRAM), a magnetic disk, or an optical disk.

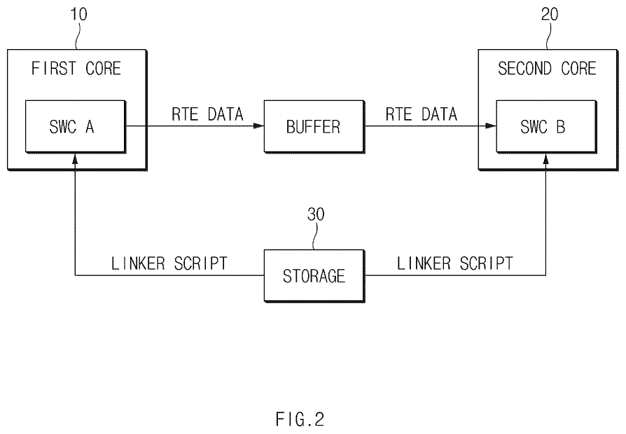

Hereinafter, a description is given in detail of a communication scheme between SWCs in the multi-core system with reference to FIGS. 2-4.

FIG. 2 is a drawing for describing a communication scheme between SWCs in a multi-core system according to an embodiment of the present disclosure.

As shown in FIG. 2, SWC A is in a state where it is executed by a first core 10 and SWC B is in a state where it is executed by a second core 20. SWC A and SWC B may perform inter-OS communication based on a buffer. In other words, SWC A, which wants to provide runtime environment (RTE) data, may store the RTE data in the buffer. Also, SWC B, which wants to obtain the RTE data, may obtain the RTE data from the buffer. SWC A and SWC B may know information about a memory set to the buffer (or a specified memory, a data storage area in the memory, or the like) using a linker script stored in storage 30. The information about the memory set to the buffer may be information indicating which memory is specified as the buffer or information indicating which area in the specified memory is specified as the buffer.

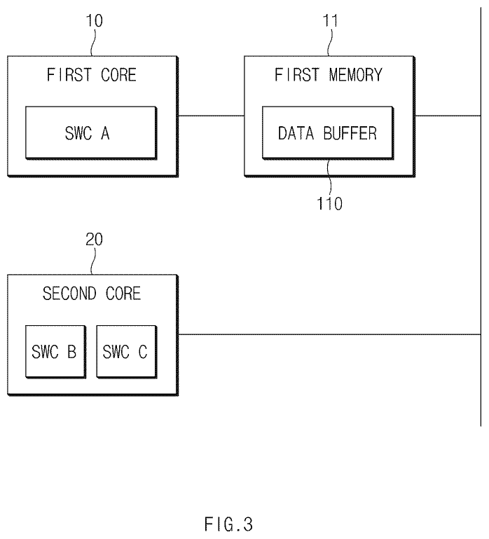

FIG. 3 is a drawing for describing an example of a process of setting a buffer when communicating between SWCs in a multi-core system according to an embodiment of the present disclosure.

As shown in FIG. 3, SWC A is in a state where it is executed by a first core 10 and SWC B and SWC C are in a state where they are executed by a second core 20. An execution cycle of SWC A is 10 ms, an execution cycle of SWC B is 20 ms, and an execution cycle of SWC C is 10 ms. In this case, a first memory 11 of a core that executes SWC A, i.e., the first core 10 is specified as a data buffer 110 in a linker script.

Thus, SWC A executed by the first core 10 may identify the first memory 11 to write RTE data based on the linker script and may write the RTE data in a data buffer area of the first memory 11.

SWC B and SWC C executed by the second core 20 may identify the first memory 11 in which the RTE data to be read is written based on the linker script and may read the RTE data from the data buffer area of the first memory 11. SWC B and SWC C executed by the second core 20 may read all the RTE data or some of the RTE data from the data buffer area of the first memory 11.

By using the first memory 11 of the first core 10, which executes SWC A with a short execution cycle, as the data buffer 110, a write latency of SWC A, which frequently accesses the first memory 11, may be minimized. As a result, an operation speed of an application may be improved.

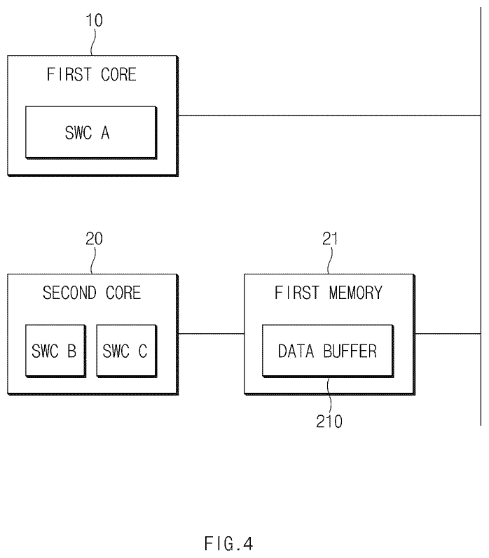

FIG. 4 is a drawing for describing another example of a process of setting a buffer when communicating between SWCs in a multi-core system according to an embodiment of the present disclosure.

As shown in FIG. 4, SWC A is in a state where it is executed by a first core 10 and SWC B and SWC C are in a state where they are executed by a second core 20. An execution cycle of SWC A is 100 ms, an execution cycle of SWC B is 20 ms, and an execution cycle of SWC C is 10 ms. In this case, a first memory 21 of a core that executes SWC C, i.e., the second core 20 is specified as a data buffer 210 in a linker script.

Thus, SWC A executed by the first core 10 may identify the first memory 21 of the second core 20 to write RTE data based on the linker script and may write the RTE data in a data buffer area of the first memory 21 of the second core 20.

SWC B and SWC C executed by the second core 20 may identify the first memory 21 in which the RTE data to be read is written based on the linker script and may read the RTE data from the data buffer area of the first memory 21. SWC B and SWC C executed by the second core 20 may read all the RTE data or some of the RTE data from the data buffer area of the first memory 21.

By using the first memory 21 of the second core 20, which executes SWC C with a short execution cycle as the data buffer 210, the read latency of SWC C, which frequently accesses the first memory 21, may be minimized. As a result, an operation speed of an application may be improved.

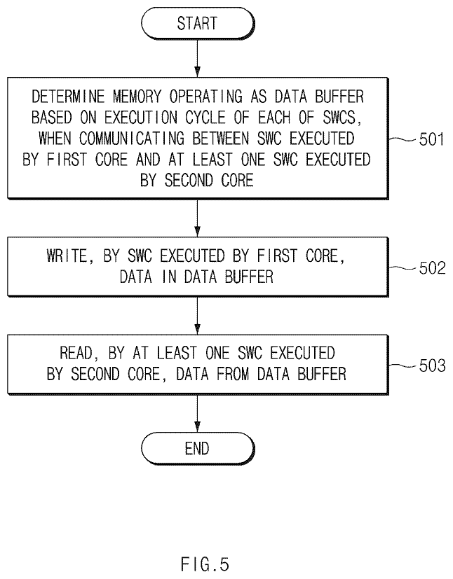

FIG. 5 is a flowchart illustrating a communication method between SWCs in a multi-core system according to an embodiment of the present disclosure.

First of all, in operation 501, when communicating between an SWC executed by a first core 10 and at least one SWC executed by a second core 20, a memory operating as a data buffer may be determined based on the execution cycle of each of the SWCs. When an execution cycle of the SWC executed by the first core 10 is shorter than or equal to an execution cycle of at least one SWC executed by the second core 20, the data buffer may be set in a memory included in the first core 10. When the execution cycle of the SWC executed by the first core 10 is longer than the execution cycle of at least one SWC executed by the second core 20, the data buffer may be set in a memory included in the second core 20.

In operation 502, the SWC executed by the first core 10 may write data in the data buffer.

In operation 503, at least one SWC executed by the second core 20 may read the data from the data buffer.

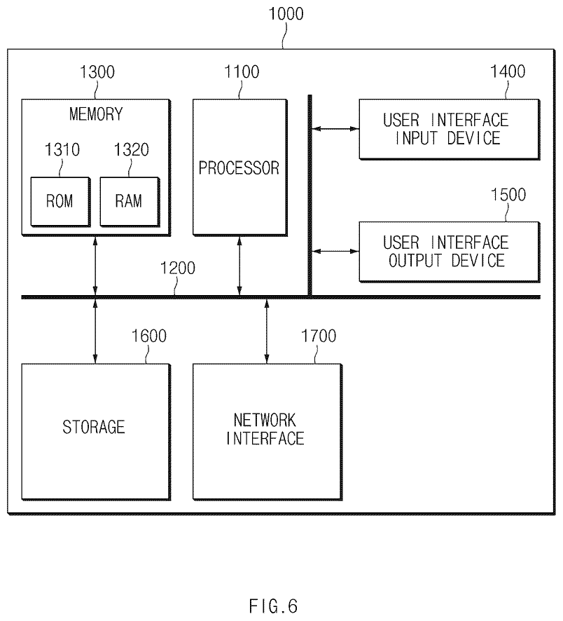

FIG. 6 is a block diagram illustrating a computing system for executing a method for communicating between SWCs according to an embodiment of the present disclosure.

Referring to FIG. 6, the above-mentioned method for communicating between the SWCs according to an embodiment of the present disclosure may be implemented using the computing system. A computing system 1000 may include at least one processor 1100, a memory 1300, a user interface input device 1400, a user interface output device 1500, storage 1600, and a network interface 1700, which are connected via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (the memory 1300 and/or the storage 1600) such as a RAM, a flash memory, a ROM, an EPROM, an EEPROM, a register, a hard disk, an SSD (Solid State Drive), a removable disk, and a compact disc ROM (CD-ROM). The storage medium may be coupled to the processor 1100. The processor 1100 may read out information from the storage medium and may write information in the storage medium. Alternatively, the storage medium may be integrated with the processor 1100. The processor and the storage medium may reside in an application-specific integrated circuit (ASIC). The ASIC may reside within a user terminal. In another case, the processor and the storage medium may reside in the user terminal as separate components.

The multi-core system for providing the communication function between the SWCs and the method therefor may determine a memory operating as a data buffer based on an execution cycle of each of the SWCs, when communicating between an SWC executed by a first core and at least one SWC executed by a second core, in the multi-core system. The multi-core system includes a plurality of cores, each of which has at least one memory. A memory access latency is thus shortened and an operation speed of an application is thus improved.

Furthermore, the multi-core system for providing the communication function between the SWCs and the method therefor may determine a memory (one of the external memories of a core) operating as a data buffer based on an execution cycle of each of the SWCs, when communicating between an SWC executed by a first core and at least one SWC executed by a second core, in the multi-core system. The multi-core system includes a plurality of cores, each of which has at least one memory. The core is thus prevented from frequently using a cache memory and the efficiency of the cache memory is thus improved.

Hereinabove, although the present disclosure has been described with reference to embodiments and the accompanying drawings, the present disclosure is not limited thereto. The embodiments may be variously modified and altered by those of ordinary skill in the art to which the present disclosure pertains without departing from the spirit and scope of the present disclosure claimed in the following claims.

Therefore, the embodiments of the present disclosure are provided to explain the spirit and scope of the present disclosure, but not to limit them. Thus, the spirit and scope of the present disclosure are not limited by the embodiments. The scope of the present disclosure should be construed based on the accompanying claims, and all the technical ideas within the scope equivalent to the claims should be included in the scope of the present disclosure.

What is claimed is:

1. A method for communicating between software components (SWCs) in a multi-core system, the method comprising:
determining, by a linker script, a memory operating as a data buffer, based on an execution cycle of each of the SWCs, when communicating between an SWC executed by a first core and at least one SWC executed by a second core;
writing, by the SWC executed by the first core, data in the data buffer; and
reading, by the at least one SWC executed by the second core, the data from the data buffer.

2. The method of claim 1, wherein the data is runtime environment (RTE) data.

3. The method of claim 1, wherein each of the first core and the second core includes at least one memory.

4. The method of claim 3, wherein the determining of the memory operating as the data buffer includes:
setting, by the linker script, the data buffer in the memory included in the first core, when an execution cycle of the SWC executed by the first core is shorter than or equal to an execution cycle of the at least one SWC executed by the second core.

5. The method of claim 3, wherein the determining of the memory operating as the data buffer includes:
setting, by the linker script, the data buffer in the memory included in the second core, when an execution cycle of the SWC executed by the first core is longer than an execution cycle of the at least one SWC executed by the second core.

6. The method of claim 3, wherein each of the at least one memory includes at least one of a program scratch-pad random-access memory (PSPR), a data scratch-pad random-access memory (DSPR), a direct-connected local memory unit (DLMU), a default application memory (DAM), a program flash memory (PFLASH), a data flash memory (DFLASH), or an extension memory (EMEM), or any combination thereof.

7. The method of claim 1, wherein the multi-core system is an autonomous driving electronic control unit (ECU) having a multi-core hardware architecture.

8. A multi-core system, comprising:
a linker script in which information about a memory operating as a data buffer is written;
a first software component (SWC) configured to write data in the data buffer based on the linker script; and
a second SWC configured to read the data from the data buffer based on the linker script,
wherein the first SWC is executed by a first core and the second SWC is executed by a second core, and
wherein the memory operating as the data buffer is determined based on an execution cycle of the first SWC and an execution cycle of the second SWC.

9. The multi-core system of claim 8, wherein the data is runtime environment (RTE) data.

10. The multi-core system of claim 8, wherein each of the first core and the second core includes at least one memory.

11. The multi-core system of claim 10, wherein the linker script sets the data buffer in the memory included in the first core when the execution cycle of the first SWC is shorter than or equal to the execution cycle of the second SWC.

12. The multi-core system of claim 10, wherein the linker script sets the data buffer in the memory included in the second core when the execution cycle of the first SWC is longer than the execution cycle of the second SWC.

13. The multi-core system of claim 10, wherein each of the at least one memory includes at least one of a program scratch-pad RAM (PSPR), a data scratch-pad RAM (DSPR), a direct-connected local memory unit (DLMU), a default application memory (DAM), a program flash memory (PFLASH), a data flash memory (DFLASH), or an extension memory (EMEM), or any combination thereof.

14. The multi-core system of claim 8, wherein the multi-core system is an autonomous driving electronic control unit (ECU) having a multi-core hardware architecture.
